(19) United States
(12) Patent Application Publication
(10) Pub. No.: US 2012/0246605 A1
(43) Pub. Date: Sep. 27, 2012

(54) STATIC TIMING ANALYZER, METHOD FOR ANALYZING STATIC TIMING AND MEDIUM STORING COMPUTER PROGRAM FOR MAKING COMPUTER PROCESSOR ANALYZE STATIC TIMING

(75) Inventors: Miyako Kitaoka, Tokyo (JP); Tomoyuki Yoda, Kawasaki-Shi (JP)

(73) Assignee: KABUSHIKI KAISHA TOSHIBA, Tokyo (JP)

(21) Appl. No.: 13/231,069

(22) Filed: Sep. 13, 2011

(30) Foreign Application Priority Data
Mar. 24, 2011 (JP) 2011-066331

(51) Int. Cl. G06F 17/50

(52) U.S. Cl. 716/113

(57) ABSTRACT

According to one embodiment, a static timing analyzer includes a time function generator, a slack function generator, a power domain voltage constant determination module, a slack value calculator, and an output module. The time function generator generates a time function based on a netlist, timing information, timing constraints information, and power domain information. The slack function generator generates a slack function based on the timing constraints information and the time function. The power domain voltage constant determination module determines a power voltage constant of the slack function based on the power domain information and the slack function such that the slack function is minimized between minimum and maximum voltages of power of the power voltage. The slack value calculator substitutes the power domain voltage constant for the slack function to calculate a slack value. The output module outputs the time function, the slack function, and the slack value.

### CROSS REFERENCE TO RELATED APPLICATION

This application is based upon and claims the benefit of priority from Japanese Patent Application No. 2011-66331, filed Mar. 24, 2011; the entire contents of which are incorporated herein by reference.

### FIELD

Embodiments described herein relate to a static timing analyzer, a method for analyzing static timing using the static timing analyzer, and a medium storing a computer program for making a computer processor analyze the static timing.

### BACKGROUND

Recently, plural power sources tend to be used to reduce an increase in power consumption with a finer pattern of an LSI (Large Scale Integration). Generally, a time necessary for a Static Timing Analysis (hereinafter referred to as an STA) is lengthened with increasing number of power sources.

There is well known a conventional technique of performing an analysis of the whole LSI and an analysis of a critical path in which it is required to make timing exact in paths of the LSI. However, in the conventional technique, the number of critical paths is increased in the case that a difference of an analysis result between the analysis of the whole LSI and the analysis of the critical path is large, thereby lengthening the time necessary for the STA. Additionally, the time necessary for the STA is lengthened because both the analysis of the whole LSI and the analysis of the critical path are performed.

### BRIEF DESCRIPTION OF THE DRAWINGS

FIG. 1 is a block diagram of a static timing analyzer 1 according to an embodiment.

FIG. 2 is a circuit diagram of a sample logical circuit of the embodiment.

FIG. 3A to 3C are views illustrating data structure of the netlist 22 of the embodiment.

FIG. 4 is a view illustrating data structure of the wire information 23 of the embodiment.

FIG. 5A to 5D are views illustrating data structure of the timing information 24 of the embodiment.

FIG. 6 is an explanatory view of the timing constraints information 25 of the embodiment.

FIG. 7 is a view illustrating data structure of the power domain information 26 of the embodiment.

FIG. 8 is a functional block diagram of the static timing analyzer 1 of the first embodiment.

FIG. 9 is a flowchart of static timing analysis processing of the first embodiment.

FIG. 10 is a view illustrating data structure of the power domain variable 900 of the first embodiment.

FIG. 11 is a functional block diagram of the static timing analyzer 1 of the second embodiment.

FIG. 12 is a flowchart of static timing analysis processing of the second embodiment.

FIG. 13 is a view illustrating data structure of the power domain correlation information 905 of the second embodiment.

FIG. 14 is an explanatory view of an advantage of the second embodiment.

### DETAILED DESCRIPTION

Embodiments will now be explained with reference to the accompanying drawings.

In general, according to one embodiment, a static timing analyzer configured to perform a static timing analysis of a logical circuit includes a time function generator, a slack function generator, a power domain voltage constant determination module, a slack value calculator, and an output module. The time function generator generates a time function based on a netlist, timing information, timing constraints information, and power domain information. The netlist expresses a connection relationship between cells of the logical circuit. The timing information expresses a delay time of the cell. The timing constraints information expresses a constraint of the delay time with respect to the logical circuit. The power domain information expresses a correspondence relationship between a power domain of the logical circuit and a range of a power voltage of the power domain. The time function is a function of the power voltage and expresses a time a signal reaches the cell. The slack function generator generates a slack function based on the timing constraints information and the time function. The slack function is a function of the power voltage and expresses a margin of a time the signal reaches the cell configured to retain data. The power domain voltage constant determination module determines a power voltage constant of the slack function based on the power domain information and the slack function such that the slack function is minimized between a minimum voltage of power and a maximum voltage of power of the power voltage. The slack value calculator substitutes the power domain voltage constant for the slack function to calculate a slack value. The output module outputs the time function, the slack function, and the slack value.

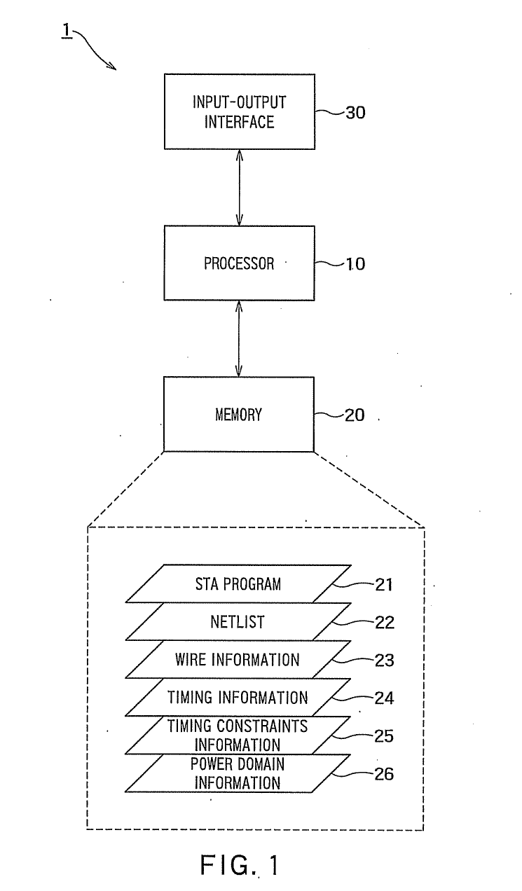

A static timing analyzer according to an embodiment will be described below. FIG. 1 is a block diagram of a static timing analyzer 1 according to an embodiment.

The static timing analyzer 1 includes a processor 10, a memory 20, and an input/output interface 30. For example, the static timing analyzer 1 is a computer. For example, the processor 10 is a central processing unit (that is, a computer processor). The memory 20 is a computer-readable storage medium. The input/output interface 30 can be connected to input devices (not illustrated) such as a keyboard and output devices (not illustrated) such as a display. In the memory 20, an STA program 21, a netlist 22, wire information 23, timing information 24, timing constraints information 25, and power domain information 26 are stored.

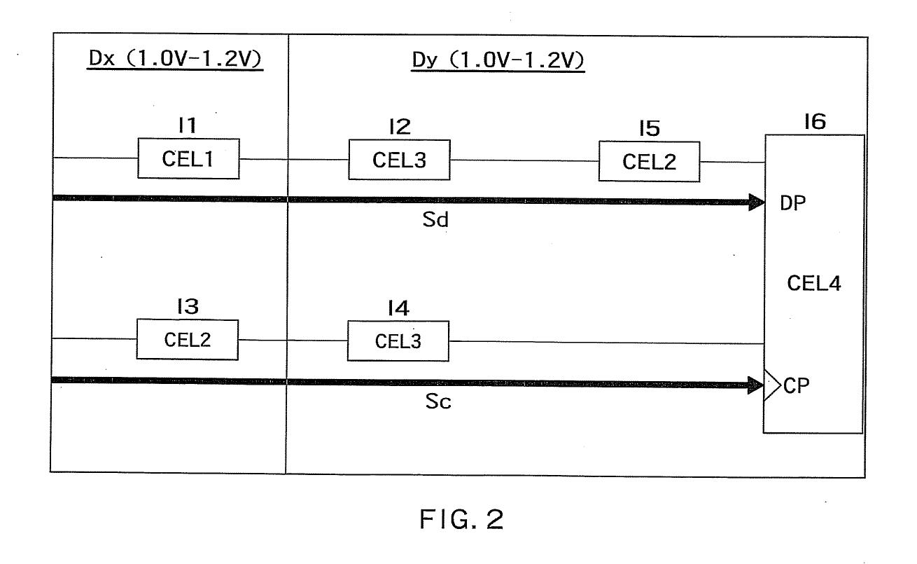

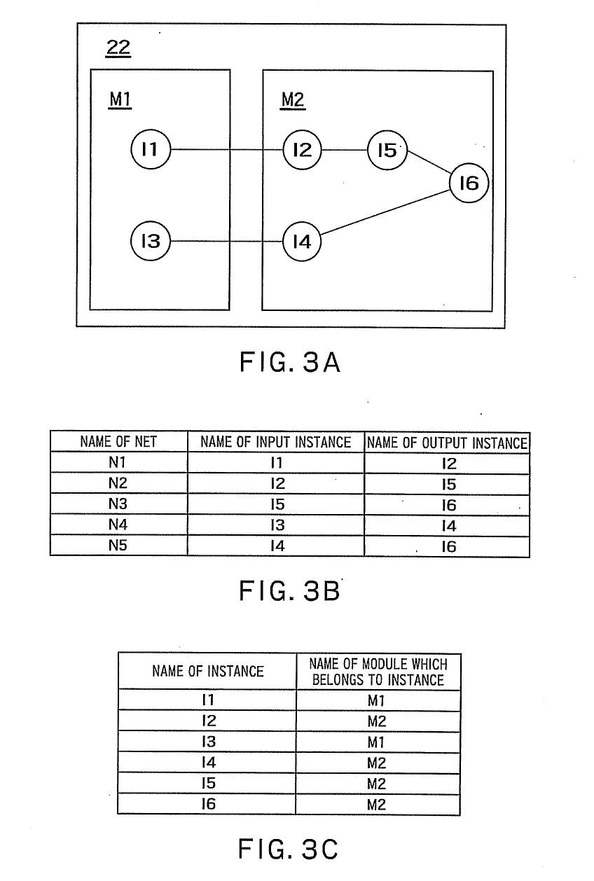

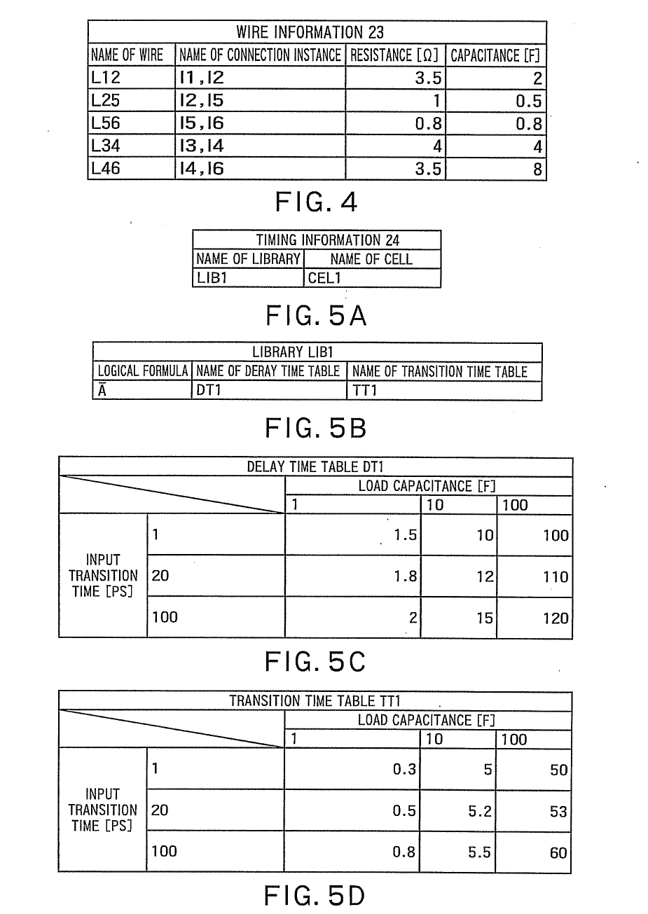

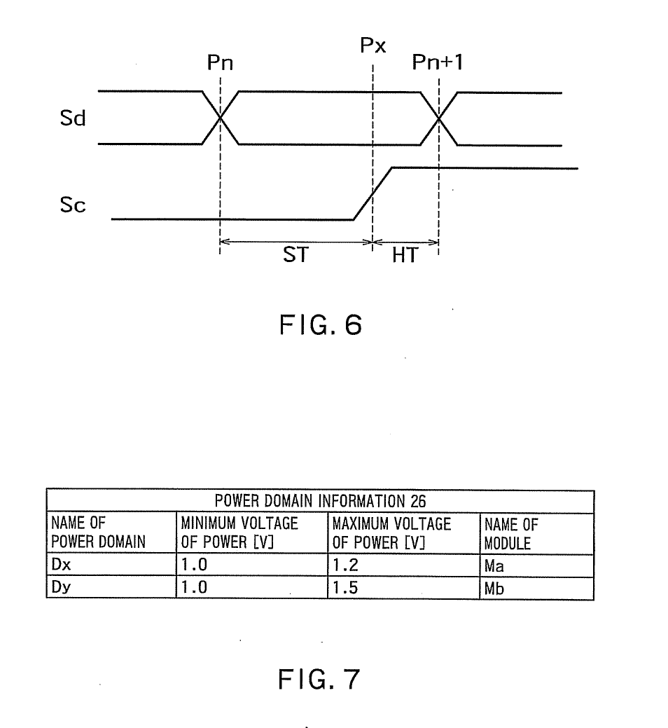

Then data referred to by the static timing analyzer of the embodiment will be described. FIG. 2 is a circuit diagram of a sample logical circuit of the embodiment. FIG. 3A to 3C are views illustrating data structure of the netlist 22 of the embodiment. FIG. 4 is a view illustrating data structure of the wire information 23 of the embodiment. FIG. 5A to 5D are views illustrating data structure of the timing information 24 of the embodiment. FIG. 6 is an explanatory view of the timing constraints information 25 of the embodiment. FIG. 7 is a view illustrating data structure of the power domain information 26 of the embodiment.

The sample logical circuit of FIG. 2 is a circuit to be analyzed by the static timing analyzer 1. The sample logical circuit includes power domains Dx and Dy. The power domain Dx has a power voltage between 1.0 V to 1.2 V. The power domain Dy has a power voltage between 1.0 V to 1.2 V. Names of library cells CEL1 to CEL4 and names of instances I1 to I6 are allocated to cells disposed in each power domain. A name of terminal DP of a data terminal that receives a data signal Sd and a name of terminal CP of a clock terminal that receives a clock signal Sc are allocated to the cell CEL4.

The netlist 22 of FIG. 3A illustrates a connection relationship among the cells of the sample logical circuit of FIG. 2. The netlist 22 includes modules M1 and M2. The module M1 corresponds to the power domain Dx of the sample logical circuit. The module M2 corresponds to the power domain Dy of the sample logical circuit. FIGS. 3B and 3C illustrate data structure of the netlist 22. As illustrated in FIG. 3B, the netlist 22 includes a “name of net”, a “name of input instance”, and a “name of output instance”. The “name of net” is identification of a circuit net. The “name of input instance” expresses a name of instance allocated to each cell of the sample logical circuit. The “name of output instance” expresses the name of instance that is allocated to the cell connected to the cell expressed by the “name of input instance”. As illustrated in FIG. 3C, the netlist 22 includes the “name of instance” and a “name of module which belongs to instance”. The “name of module which belongs to instance” expresses a name of module to which the cell expressed by the “name of instance” belongs. For example, the netlist 22 is described in a Verilog format.

The wire information 23 of FIG. 4 expresses a connection relationship among wires of the netlist 22 of FIG. 3. The wire information 23 includes a “name of wire”, a “name of connection instance”, a “resistance [Ω]” and a “capacitance [F]”. The “name of wire” expresses a name of a wire allocated to the wire between the two cells. The “name of connection instance” expresses a combination of the “name of input instance” and the “name of output instance” of the netlist 22. The “resistance [Ω]” expresses a resistance of the wire expressed by the “name of wire”. The “capacitance [F]” expresses a capacitance of the wire expressed by the “name of wire”. For example, the wire information 23 is described in a SPEF (Standard Parasitic Extraction Format).

The timing information 24 of FIG. 5A includes a “name of library” and a “name of cell”. The “name of library” expresses a library unique to the timing information 24. The “name of cell” expresses the cell corresponding to the library expressed by the “name of library”. The library LIB1 of FIG. 5B includes a “logical formula”, a “name of delay time table”, and a “name of transition time table”. The “logical formula” expresses a logical formula of the cell expressed by the “name of cell” of FIG. 5A.

The “name of delay time table” expresses a delay time table corresponding to the library LIB1. The “name of transition time table” expresses a transition time table corresponding to the library LIB1. The delay time table DT1 of FIG. 5C expresses a delay time corresponding to input transition time [ps] and capacitance [F]. The transition time table 111 of FIG. 5D expresses a transition time corresponding to input transition time [ps] and load capacitance [F]. That is, the timing information 24 expresses the delay time of the cell of the sample logical circuit. For example, the timing information 24 is described in a Liberty format.

As illustrated in FIG. 6, the timing constraints information 25 includes a setup constraint ST and a hold constraint HT. The setup constraint ST is a constraint of a time from a point Pn (n is an integer of 0 or more) at which a signal level of the data signal Sd changes to a point Px at which a signal level of the clock signal Sc changes. The hold constraint HT is a constraint of a time from the point Px to a cross point Pn+1. That is, the timing constraints information 25 expresses the constraint of the delay time with respect to the sample logical circuit. For example, the timing constraints information 25 is described in an SDC (Synopsys Design Constraint) format.

The power domain information 26 of FIG. 7 includes a “name of power domain”, a “minimum voltage of power [V]”, a “maximum voltage of power [V]”, and a “name of module”. The “name of power domain” expresses a power domain, of the sample logical circuit of FIG. 2. The “minimum voltage of power [V]” and the “maximum voltage of power [V]” express a range of a power voltage of the power domain expressed by the “name of power domain”. The “name of module” expresses the module of the netlist 22 of FIG. 3 corresponding to the “name of power domain”. That is, the power domain information 26 expresses a correspondence relationship among the power domain of the sample logical circuit, the range of the power voltage of the power domain, and the module corresponding to the power domain. For example, the power domain information 26 is described in a UPF (Unified Power Format) or a CPF (Common Power Format).

### First Embodiment

A first embodiment will be described. The first embodiment is an example of a static timing analyzer that outputs the result of STA irrespective of presence or nonpresence of a correlation between plural power domains.

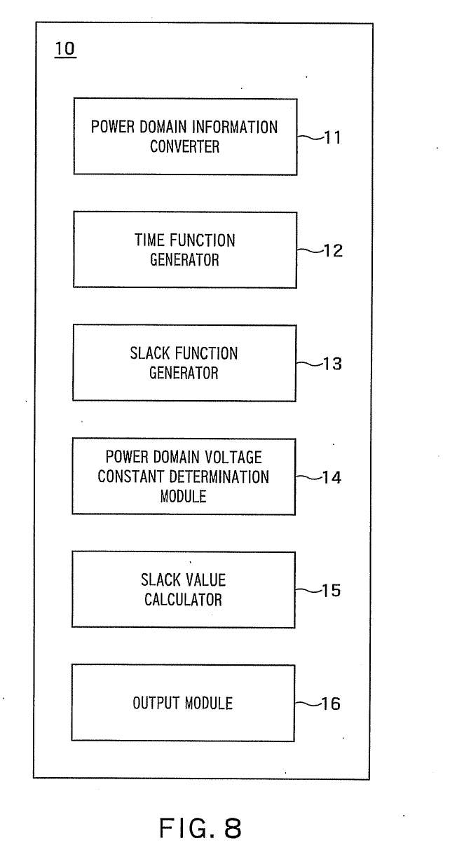

A function of the static timing analyzer 1 of the first embodiment will be described. FIG. 8 is a functional block diagram of the static timing analyzer 1 of the first embodiment.

A processor 10 that activates a STA program 21 of FIG. 8 has functions (a power domain information converter 11, a time function generator 12, a slack function generator 13, a power domain voltage constant determination module 14, a slack value calculator 15, and an output module 16) of the static timing analyzer 1.

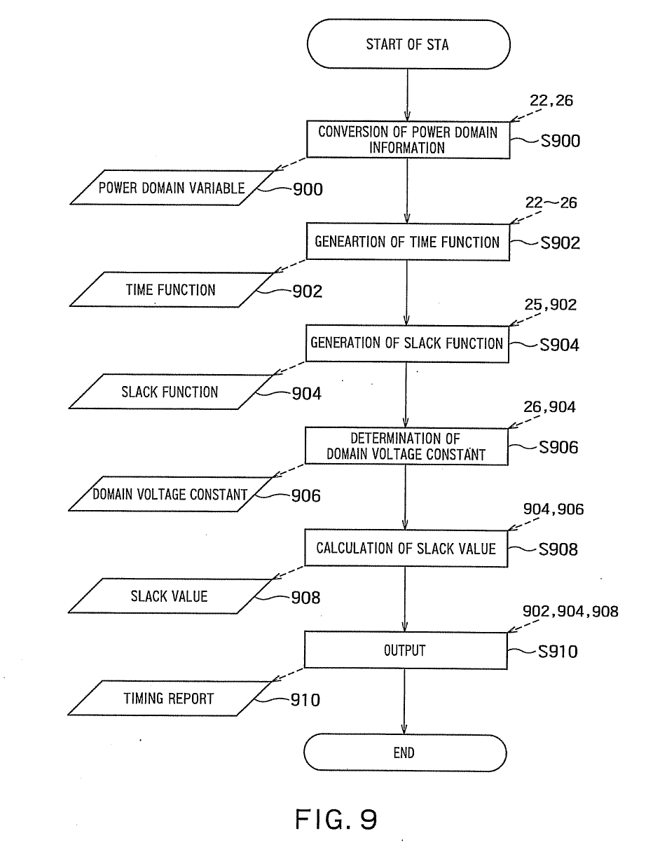

An operation of the static timing analyzer 1 of the first embodiment will be described below. FIG. 9 is a flowchart of static timing analysis processing of the first embodiment.

The static timing analysis processing of FIG. 9 includes conversion of power domain information (S900), generation of time function (S902), generation of slack function (S904), determination of domain voltage constant (S906), calculation of slack value (S908), and output (S910).

<S900> The power domain information converter 11 converts the power domain information 26 into a power domain variable 900 based on the netlist 22. Although the power domain information 26 is not supported, the power domain can be dealt with as a variable using the power domain variable 900, by a statistical static timing analysis tool. That is, the power domain information converter 11 processes the power domain information 26 such that the statistical static timing analysis tool deals with the power domain as the variable.

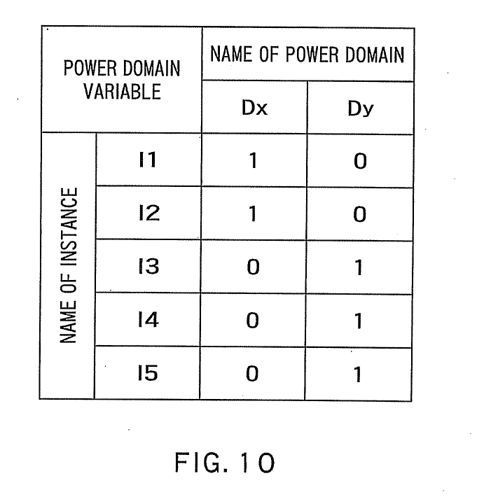

FIG. 10 is a view illustrating data structure of the power domain variable 900 of the first embodiment. The power domain variable 900 is information expressing the power domain on which the cell depends and binary information (0 or 1) in each “name of instance” and in each “name of power domain”. Referring to FIG. 10, the instances I1 and I2 belong to the power domain Dx, and the instances I3 to I5 belong to power domain Dy. That is, the cells corresponding to the instances I1 and I2 depend only on the power voltage of the power domain Dx, and the cells corresponding to the instances I3 to I5 depend only on the power voltage of the power domain Dy.

<S902> The time function generator 12 generates a time function 902 based on the netlist 22, the timing information 24, the timing constraints information 25, and the power domain information 26. The time function 902 is a function of the power voltage of the power domain and expresses a time a signal reaches each cell. An equation 1 is a data time function Td that expresses a time the data signal Sd reaches the data terminal DP of the cell CEL4. An equation 2 is a clock time function Tc that expresses a time the clock signal Sc reaches the clock terminal CP of the cell CEL4. In the equations 1 and 2, Add to Cdd and Acd to Ccd are constants, Vx is a power domain variable of the power domain Dx, and Vy is a power domain variable of the power domain Dy. The time function 902 is not limited to the linear function, but the time function 902 may be an m-order (m is an integer of 2 or more) function.

[Formula 1]

Td=Add+Bdd*Vx+Cdd*Vy (equation 1)

[Formula 2]

Tc=Acd+Bcd*Vx+Ccd*Vy (equation 2)

<S904> The slack function generator 13 generates a slack function 904 based on the timing constraints information 25 and the time function 902. The slack function 904 is a function of the power voltage of the power domain and expresses a margin of a time a signal reaches the cell (flip-flop or memory) that retains data in the cells of the sample logical circuit. For example, the time function generator 12 generates the slack function 904 as expressed in the equation 3. In the equation 3, P is a period of the clock signal Sc, and As to Cs are constants. The slack function 904 is not limited to the linear function, but may be an m-order function (m is an integer of 2 or more).

[Formula 3]

S=P−Td−Tc=(P−Add−Acd)−(Bdd−Bcd)*Vx−(Cdd−Ccd)*Vy=As+BS*Vx+Cs*Vy (equation 3)<

<S906> The power domain voltage constant determination module 14 determines a power domain voltage constant 906 based on the power domain information 26 and the slack function 904. The power domain voltage constant 906 is a value in which the power voltage of the power domain is uniquely fixed. The power domain voltage constant determination module 14 determines the constant (power voltage constant 906) of a slack function S such that the slack function S becomes the minimum between the minimum voltage of power and the maximum voltage of power. For example, in the case in which the slack function 904 is the linear function, the power voltage constant 906 is determined based on a sign of a coefficient of the slack function 904.

<S908> The slack value calculator 15 substitutes the power domain voltage constant 906 for the slack function 904 to calculate a slack value 908.

<S910> The output module 16 outputs a timing report 910 expressing the result of the STA. The timing report 910 includes the time function 902, the slack function 904, and the slack value 908, which are described in a predetermined format.

According to the first embodiment, the time function 902, the slack function 904, and the slack value 908 are output in the single STA. Accordingly, the time necessary for the STA can be shortened. Particularly, when the first embodiment is applied to the case of the related art in which the STA is performed 2^{k} (k is the number of power domains) times, the result similar to that of the related art can be obtained in the single STA.

### Second Embodiment

A second embodiment will be described below. The second embodiment is an example of a static timing analyzer that outputs the result of the STA in consideration of the correlation in the case in which there is the correlation between plural power domains.

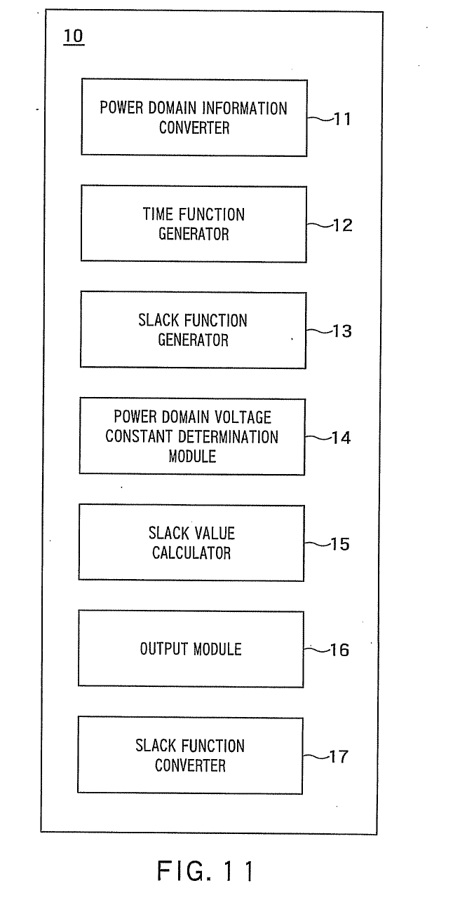

A function of the static timing analyzer 1 of the second embodiment will be described. FIG. 11 is a functional block diagram of the static timing analyzer 1 of the second embodiment.

The processor 10 that activates the STA program 21 of FIG. 8 includes the functions (the power domain information converter 11, the time function generator 12, the slack function generator 13, the power domain voltage constant determination module 14, the slack value calculator 15, the output module 16, and a slack function converter 17) of the static timing analyzer 1.

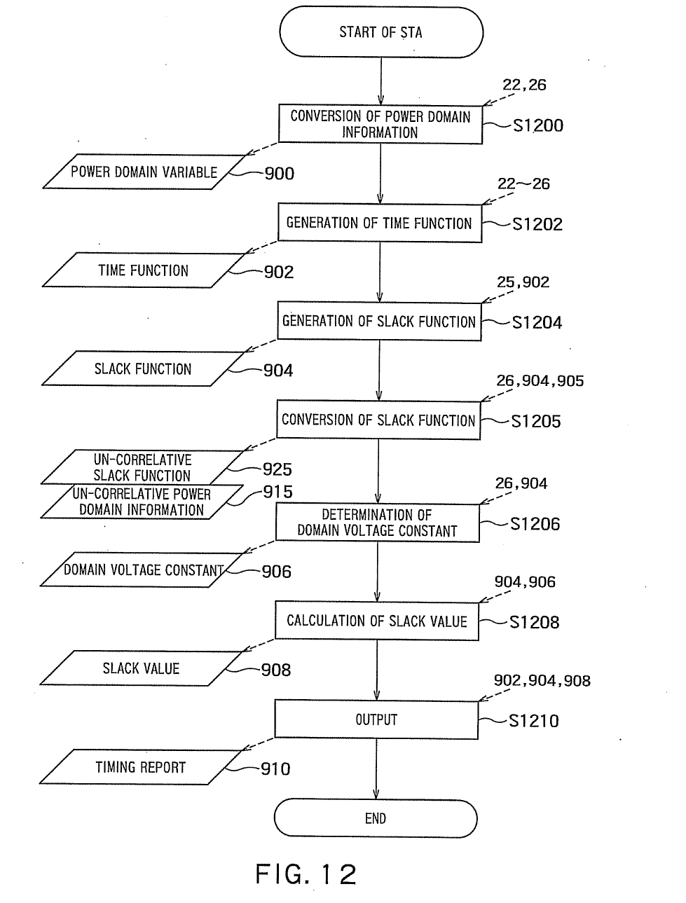

An operation of the static timing analyzer 1 of the second embodiment will be described below. FIG. 12 is a flowchart of static timing analysis processing of the second embodiment.

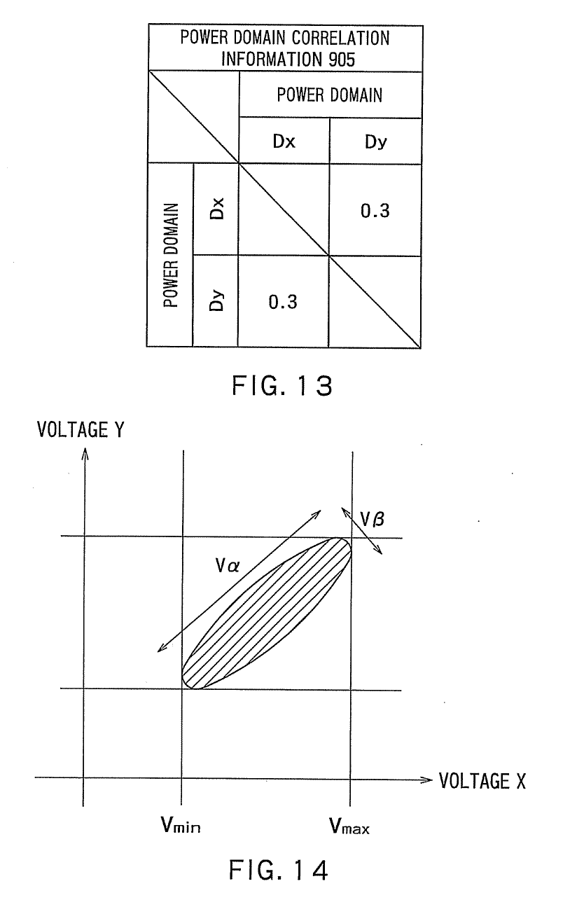

The static timing analysis processing of FIG. 12 includes conversion of power domain information (S1200), generation of time function (S1202), generation of slack function (S1204), conversion of slack function (S1205), determination of domain voltage constant (S1206), calculation of slack value (1208), and output (S1210). The conversion of power domain information (S1200), the generation of time function (S1202), the generation of slack function (S1204), the calculation of slack value (1208), and the output (S1210) are similar to those of the first embodiment.

<S1205> Using a principal component analysis method, based on power domain correlation information 905, the slack function converter 17 converts the slack function 904 into an un-correlative slack function 925 while converting the power domain information 26 into an un-correlative power domain information 915. At this point, in the slack function 904, there is the correlation between the plural power domains. FIG. 13 is a view illustrating data structure of the power domain correlation information 905 of the second embodiment. The power domain correlation information 905 expresses the correlation between the power domains Dx and Dy in the slack function 904. A degree of the correlation is increased with increasing value of the power domain correlation information 905. The value “0” of the power domain correlation information 905 means un-correlative, the value “1” means a complete correlation, and the value between “0” and “1” means a partial correlation.

For example, the slack function converter 17 generates a variance-covariance matrix of the power domains Dx and Dy. In a variance-covariance matrix (i,j), an element Mii is expressed by an equation 4, and an element Mij is expressed by an equation 5. In the equations 5 and 6, vi is a degree of variation of the power voltage of the power domain Di. In the case of FIG. 13, the variance-covariance matrix expressed by an equation 6 is generated.

[Formula 4]

Mii=vi*vi (equation 4)

[Formula 5]

Mij=Rij*vi*vj (equation 5)

$$\begin{matrix}[ Formula 6 ] & \\ ( \begin{matrix}0.2 \times 0.2 & 0.3 \times 0.2 \times 0.2 \\ 0.3 \times 0.2 \times 0.2 & 0.2 \times 0.2\end{matrix} ) = ( \begin{matrix}0.04 & 0.012 \\ 0.012 & 0.04\end{matrix} ) & ( equation 6 )\end{matrix}$$

Then the slack function converter 17 calculates an eigenvalue and an eigenvector of the variance-covariance matrix. In the case of the equation 6, a combination of the eigenvalue and the eigenvector is {eigenvalue, eigenvector}={0.052,(1,1)} and {0.028,(1,−1)}. The eigenvector is a virtual power voltage of a virtual power domain. The eigenvalue is a square of a degree of variation of the virtual power voltage. An equation 7 expresses the un-correlative power domain information 915. In the equation 7, Vα is a virtual power voltage of a virtual power domain α, and Vβ is a virtual power voltage of a virtual power domain β. In the case of the equation 6, the virtual power voltage Vα has the degree of variation of 0.228 (=√0.052) V, and the virtual power voltage Vβ has the degree of variation of 0.167 (=40.028) V. That is, the virtual power voltage Vα ranges from 2.086 V to 2.314 V, and the virtual power voltage Vβ ranges from −0.084 V to 0.084 V. The virtual power voltages Vα and Vβ are values that have meanings only in the equation 7 and have no influence on the sample logical circuit. That is, it is not to say that the sample logical circuit is operated in the ranges of the virtual power voltages Vα and Vβ.

[Formula 7]

Vα=Vx+Vy

Vβ=Vx−Vy (equation 7)

Then the slack function converter 17 replaces the constants As to Cs of the slack function S of the equation 3 by un-correlative constants Ans to Cns to generate an un-correlative slack function S′ of an equation 8, thereby obtaining the un-correlative slack function 925 and the un-correlative power domain information 915, which can be dealt with by the power domain voltage constant determination module 14.

[Formula 8]

S=Ans+Bns*Vα+Cns*Vβ (equation 8)

<S1206> The power domain voltage constant determination module 14 determines the power domain voltage constant 906 based on the un-correlative power domain information 915 and the un-correlative slack function 925. The power domain voltage constant determination module 14 determines the power voltage constant 906 such that the un-correlative slack function becomes the minimum between the minimum voltage of power and the maximum voltage of power. For example, in the case in which the un-correlative slack function 925 is the linear function, the power voltage constant 906 is determined based on the sign of the coefficient of the un-correlative slack function 925.

According to the second embodiment, the slack function 904 is converted into the un-correlative slack function 925, and the power domain information 26 is converted into the un-correlative power domain information 915. Accordingly, even in the case in which there is the correlation between the plural power domains, the time necessary for the STA is shortened, and the optimum slack value 908 is obtained compared with the first embodiment (see FIG. 14).

At least a portion of the static timing analyzer 1 according to the above-described embodiments may be composed of hardware or software. When at least a portion of the static timing analyzer 1 is composed of software, a program for executing at least some functions of the static timing analyzer 1 may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the static timing analyzer 1 according to the above-described embodiment may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A static timing analyzer configured to perform a static timing analysis of a logical circuit, the analyzer comprising:
a time function generator configured to generate a time function based on a netlist, timing information, timing constraints information, and power domain information, the netlist expressing a connection relationship between cells of the logical circuit, the timing information expressing a delay time of the cell, the timing constraints information expressing a constraint of the delay time with respect to the logical circuit, the power domain information expressing a correspondence relationship between a power domain of the logical circuit and a range of a power voltage of the power domain, the time function being a function of the power voltage and expressing a time a signal reaches the cell;
a slack function generator configured to generate a slack function based on the timing constraints information and the time function, the slack function being a function of the power voltage and expressing a margin of a time the signal reaches the cell configured to retain data;
a power domain voltage constant determination module configured to determine a power voltage constant of the slack function based on the power domain information and the slack function such that the slack function is minimized between a minimum voltage of power and a maximum voltage of power of the power voltage;
a slack value calculator configured to substitute the power domain voltage constant for the slack function to calculate a slack value; and
an output module configured to output the time function, the slack function, and the slack value.

2. The analyzer of claim 1, further comprising a slack function converter configured to convert the slack function into an un-correlative slack function based on power domain correlation information expressing a correlation between the power domains in the slack function.

3. The analyzer of claim 2, wherein the slack function converter replaces a constant of the slack function by an un-correlative constant to generate the un-correlative slack function.

4. The analyzer of claim 2, wherein the slack function converter further generates a variance-covariance matrix of the power domains, calculates an eigenvector of the variance-covariance matrix, and generates the un-correlative slack function based on the eigenvector.

5. The analyzer of claim 3, wherein the slack function converter further generates a variance-covariance matrix of the power domains, calculates an eigenvector of the variance-covariance matrix, and generates the un-correlative slack function based on the eigenvector.

6. A method for analyzing static timing using a static timing analyzer configured to perform a static timing analysis of a logical circuit, the method comprising:
generating a time function based on a netlist, timing information, timing constraints information, and power domain information, the netlist expressing a connection relationship between cells of the logical circuit, the timing information expressing a delay time of the cell, the timing constraints information expressing a constraint of the delay time with respect to the logical circuit, the power domain information expressing a correspondence relationship between a power domain of the logical circuit and a range of a power voltage of the power domain, the time function being a function of the power voltage and expressing a time a signal reaches the cell;
generating a slack function based on the timing constraints information and the time function, the slack function being a function of the power voltage and expressing a margin of a time the signal reaches the cell configured to retain data;
determining a power voltage constant of the slack function based on the power domain information and the slack function such that the slack function is minimized between a minimum voltage of power and a maximum voltage of power of the power voltage;
substituting the power domain voltage constant for the slack function to calculate a slack value; and
outputting the time function, the slack function, and the slack value.

7. The method of claim 6, further comprising converting the slack function into an un-correlative slack function based on power domain correlation information expressing a correlation between the power domains in the slack function.

8. The method of claim 7, wherein in converting the slack function, a constant of the slack function is replaced by an un-correlative constant to generate the un-correlative slack function.

9. The method of claim 7, wherein in converting the slack function, a variance-covariance matrix of the power domains is further generated, an eigenvector of the variance-covariance matrix is further calculated, and the un-correlative slack function is further generated based on the eigenvector.

10. The method of claim 8, wherein in converting the slack function, a variance-covariance matrix of the power domains is further generated, an eigenvector of the variance-covariance matrix is further calculated, and the un-correlative slack function is further generated based on the eigenvector.

11. A medium storing a computer program for making a computer processor analyze static timing of a logical circuit, the computer program comprising:
generating a time function based on a netlist, timing information, timing constraints information, and power domain information, the netlist expressing a connection relationship between cells of the logical circuit, the timing information expressing a delay time of the cell, the timing constraints information expressing a constraint of the delay time with respect to the logical circuit, the power domain information expressing a correspondence relationship between a power domain of the logical circuit and a range of a power voltage of the power domain, the time function being a function of the power voltage and expressing a time a signal reaches the cell;
generating a slack function based on the timing constraints information and the time function, the slack function being a function of the power voltage and expressing a margin of a time the signal reaches the cell configured to retain data;
determining a power voltage constant of the slack function based on the power domain information and the slack function such that the slack function is minimized between a minimum voltage of power and a maximum voltage of power of the power voltage;
substituting the power domain voltage constant for the slack function to calculate a slack value; and
outputting the time function, the slack function, and the slack value.

12. The medium of claim 11, further comprising converting the slack function into an un-correlative slack function based on power domain correlation information expressing a correlation between the power domains in the slack function.

13. The medium of claim 12, wherein in converting the slack function, a constant of the slack function is replaced by an un-correlative constant to generate the un-correlative slack function.

14. The medium of claim 12, wherein in converting the slack function, a variance-covariance matrix of the power domains is further generated, an eigenvector of the variance-covariance matrix is further calculated, and the un-correlative slack function is further generated based on the eigenvector.

15. The medium of claim 13, wherein in converting the slack function, a variance-covariance matrix of the power domains is further generated, an eigenvector of the variance-covariance matrix is further calculated, and the un-correlative slack function is further generated based on the eigenvector.
